(19) United States
(12) Patent Application Publication
(10) Pub. No.: US 2004/0074986 A1
(43) Pub. Date: Apr. 22, 2004

(54) Irrigator with a modulated jet

(76) Inventor: Giorgio Gaiti, Correggio (IT)

Correspondence Address: PEARNE & GORDON LLP, 1801 EAST 9TH STREET, SUITE 1200, CLEVELAND, OH, 44114-3108, US

(21) Appl. No.: 10/467,703

(22) PCT Filed: Jan. 28, 2002
(86) PCT No.: PCT/IT02/00042

(30) Foreign Application Priority Data
Feb. 28, 2001 (IT) RE2001A000016

(51) Int. Cl. B05B 3/00

(52) U.S. Cl. 239/225.1

(57) ABSTRACT

An irrigator with a rotating head (2), in which the rotating head, from which a jet of liquid exits, is controlled by a turbine device actuated by the liquid in a pressurised stated and feeding the irrigator, and is made to rotate about a usually vertical axis and to alternate through an arc of a predetermined entity. The invention comprises means for cyclically varying a delivery of outletting liquid in a pressurised state, which are powered by a turbine (3) actuated by the flow of pressurised liquid crossing the rotating head (2).

### TECHNICAL FIELD

The invention relates to an rotating-head irrigator in which the modulation, or cyclical variation, of the water jet is adjustable. Specifically, though not exclusively, the invention applies to the field of irrigation for green surfaces, such as lawns, or gardens and the like.

### BACKGROUND ART

The prior art teaches irrigators able to produce a jet of water that rotates through a predetermined-entity arc, alternating from one end of the arc to the other. The jet therefore covers part of a circular portion of surface. The jet is moved by the energy of the water itself, which before being sprayed out is made to power tiny turbines which activate the mechanisms necessary for producing motion.

Known realisations have the drawback of not spraying the whole arc area sufficiently uniformly. Solutions proposed to solve this problem are very numerous, but all unsatisfactory inasmuch as incapable of guaranteeing a sufficient equality of water distribution.

There also exist in the prior art rotating turbine irrigators which achieve an adequate wetting of the area by breaking up the water jet with a manual mechanical system actuated by an operator, with this system, however, the maximum angular range of the irrigator is considerably limited, forcing the operator to intervene at least once during a complete cycle so as to make sure the whole area is well watered.

Further, some known irrigator models are quite noisy when operating, while with through an exit opening 23b. An impeller shaft 25 is rotatably mounted coaxially of the housing 23 and includes a series of stacked impeller blades 24 arranged coextensively and coaxially of the housing 23, wherein fluid from the second conduit 13 directed through the housing 23 effects rotation of the impeller shaft 25 and ultimately a driven gear 27 that projects coaxially and exteriorly through an upper end of the housing 23.

Water directed through the impeller housing exit opening 23b is directed therefrom through a central conduit 30 and through a deflector hub 31 that includes a conical support stem that is mounted within a central opening conical outlet seat 32 of the central conduit 30.

Water directed therethrough effects rotation of a deflector plate 34 mounted orthogonally to an upper terminal end of the conical support stem 33. The deflector plate 34 is of an eccentrically weighted configuration and includes at least one radial recess 35 directed through a peripheral edge of the deflector plate 34.

The eccentrically weighted deflector plate 34 will selectively baffle water directed to the plurality of outer opening groups 22 through an outer opening group conduit in fluid communication with the central conduit 30.

The output drive gear 26 is in operative communication with a driven gear 27 that is mounted about a rotary hub 28 that in turn includes a rotary hub outer thread 28a that threadedly mounts the central cap housing 20 that includes a central cap inner threads 29. In this manner, rotation of the central cap housing 20, as well as the eccentrically weighted deflector hub 31 effects pulsing of water through the axial openings 21 and the outer opening groups 22.

From U.S. Pat. No. 6,182,909 is known a rotary drive sprinkler has a nozzle assembly 1 having a recess 44 in a cylindrical housing 16 for receiving a cylindrical nozzle selection disc 40 having a plurality of nozzle openings 42. The cylindrical nozzle selection disc 40 is manually rotatable to place one of its nozzle openings 42 in an exit flow passage 15 in the cylindrical housing. is activated by the pressurised water feeding into the irrigator. The rotating head 2 is thus rotated about an axis (normally vertical or nearly so), denoted by y, so that it alternates through an arc of predetermined entity.

The irrigator 1, more specifically the rotating head 2, comprises means for cyclically varying, or modulating, the delivery of the exiting jet, which means are driven by a turbine 3 actuated by the flow of liquid crossing through the rotating head 2.

The means for cyclically varying the delivery of the exiting jet are arranged downstream, with reference to the flow direction of the fluid (water) which crosses through the irrigator, of the known turbine device which controls the rotation of the rotating head 2. The means comprise a rotating organ which is driven by the turbine 3 through a gear mechanism 4 and which is predisposed to interact with a fixed member in order to create, during the course of a single rotation, various outflow conditions in the exiting jet.

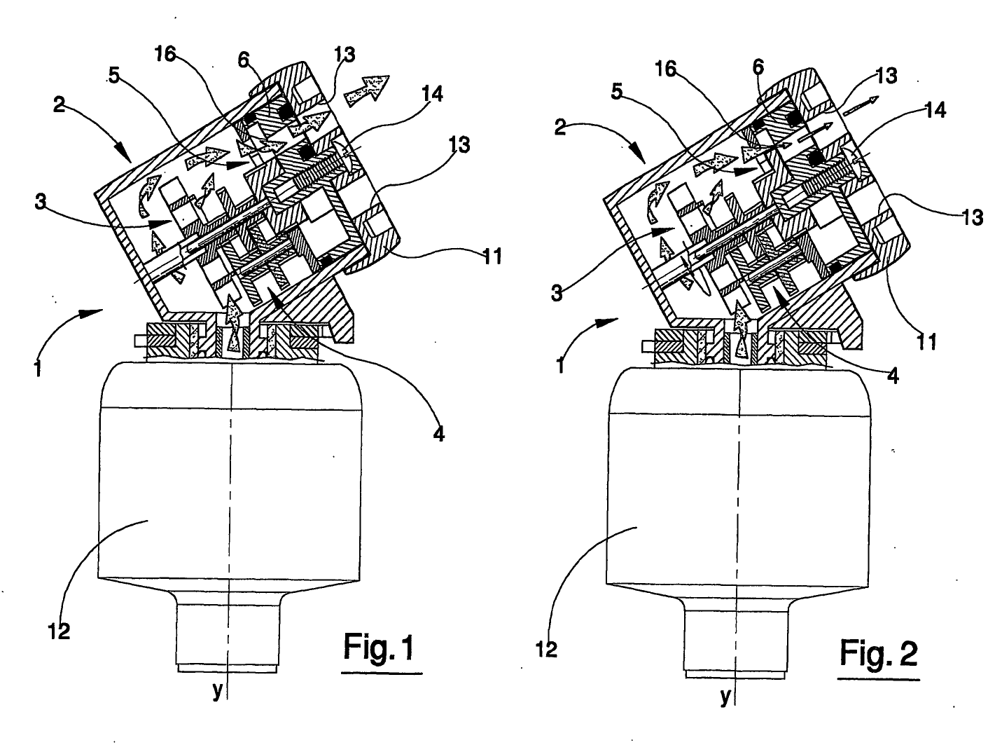

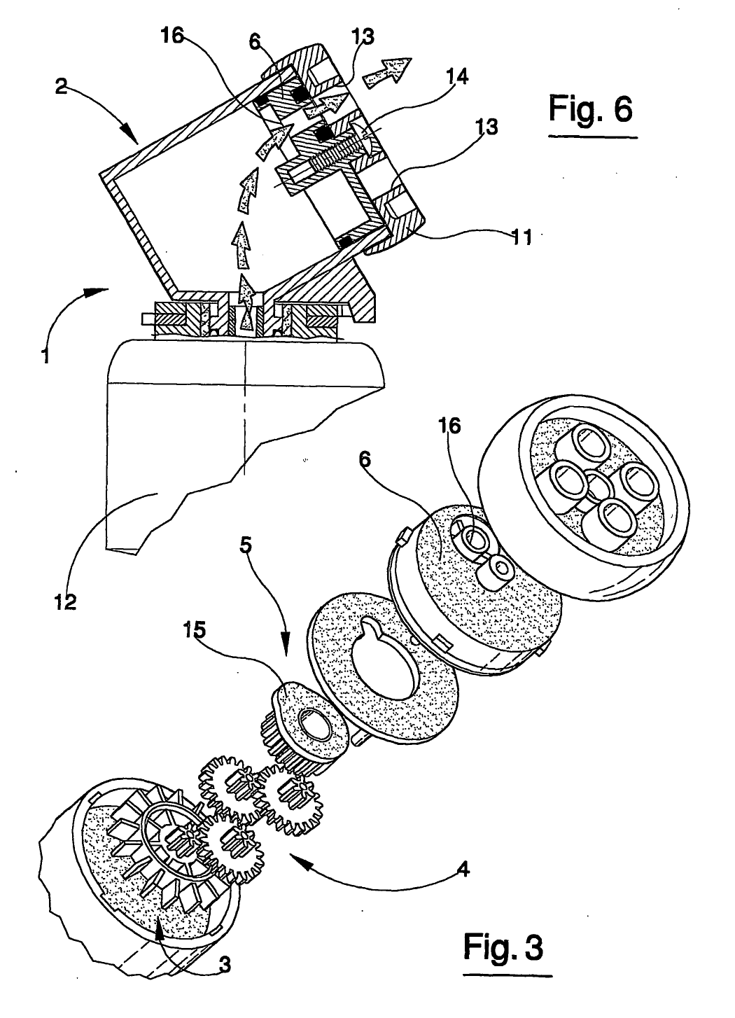

In the example of the embodiment of FIGS. 1 and 2, the rotating organ is constituted by a rotating obturator 5 which is predisposed to interact, by means of a shaped part 15 thereon, with an outlet hole 16 afforded on the front surface of a fixed member 6, which the rotating obturator 5 faces.

A cover 11 is removably constrained on the fixed member 6, which cover 11 bears a plurality of fixed nozzles 13 of different characteristics which can be aligned with the outlet hole 16 in order to create jets of various characteristics.

The cover 11 is fixed by a screw 14 and can be rotated through a plurality of positions so that each fixed nozzle 13 can be aligned with the outlet hole 16 and thus give rise to its characteristic jet. The cover 11 is kept in position by usual click-type means for reference.

The rotation of the rotating obturator 5 means that its shaped part 15 is periodically brought before the outlet hole 16 so as to produce a partial closure thereof at each rotation. This chokes the jet as well as weakening its force, which lead to a progressive reduction of the reach of the jet. The entity and progression of this reduction are influenced by the shape of the shaped part 15 of the obturator 5.

In the second illustrated embodiment, the rotating organ is constituted by a rotating nozzle 7 which exhibits an unaligned fluid inlet section 17 with respect to the rotation axis and is predisposed to interact cyclically with the surface of a fixed member 8 which is periodically aligned with it during a rotation of the nozzle 7 about its axis.

The rotating nozzle 7 exhibits a fluid outlet section 27 which is unaligned with respect to an axis of rotation of the nozzle 7.

Also in this embodiment the periodic passage of the inlet section 17 in front of the fixed member 8 causes a choking and thus a weakening of the water jet, which is manifested in a progressive weakening of the distance achieved by the jet.

Thus it is possible, as in the previous embodiment, to irrigate not only the edge of the arc, but also the radial direction from the irrigator to the edge of the arc.

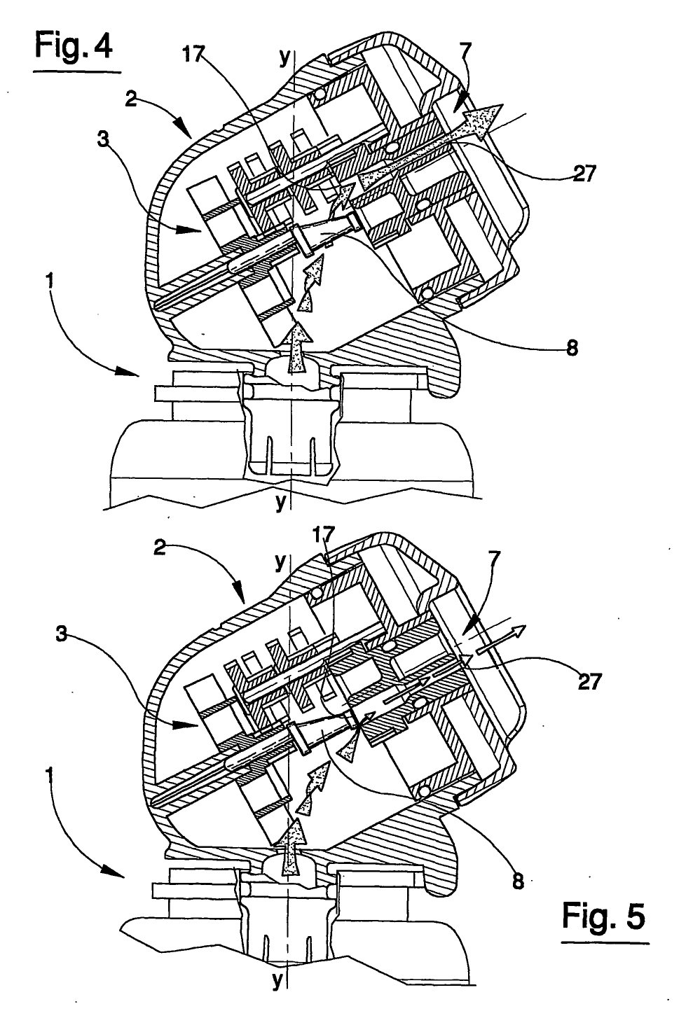

FIG. 6 shows a simplified embodiment, in which the jet variation is achieved by rotating the cover 11 so as to bring one of the nozzles 13 in line with the outlet hole 16.

With the invention it is possible to cover a whole area, including the radii of the arc, with no need for operator intervention. The irrigator is also silent, easily adjustable by the operator and able to produce jets having different characteristics.

1). An irrigator with a rotating head (2), in which the rotating head, from which a jet of liquid exits, is controlled by a turbine device actuated by the liquid in a pressurised stated and feeding the irrigator, and is made to rotate about a vertical axis and to alternate through an arc of a predetermined entity, comprising means for cyclically varying a delivery of outletting liquid.

2). The irrigator of claim 1, wherein the means for cyclically varying a delivery of outletting liquid are actuated by a turbine (3) set in motion by a flow of the liquid crossing through the rotating head (2).

3). The irrigator of claim 2, wherein the means for cyclically varying a delivery of outletting liquid are arranged downstream, with reference to a direction of the liquid crossing the rotating head (2), of the turbine device controlling the rotation of the rotating head (2).

4). The irrigator of claim 3, wherein the means for cyclically varying a delivery of outletting liquid comprise a rotating organ actuated by the turbine (3) through a gear mechanism (4), which rotating organ is predisposed to interact with a fixed member in order to create, during a course of a single rotation of the rotating organ, various conditions of flow in an outletting jet of the liquid.

5). The irrigator of claim 4, wherein the rotating organ is constituted by a rotating obturator (5) which is predisposed to interact, by means of a shaped part (15) thereof, with an outlet hole (16) afforded on a front surface of a fixed member (6) which the rotating obturator (5) faces.

6). The irrigator of claim 4, wherein the rotating organ is constituted by a rotating nozzle (7), which exhibits a fluid inlet section (17) which is unaligned with a rotation axis thereof and which is predisposed to interact cyclically with a surface of a fixed member (8) coming periodically into alignment there-with during a rotation about an axis thereof.

7). The irrigator of claim 6, wherein the rotating nozzle (7) exhibits a fluid outlet section (27) which is unaligned with respect to an axis of rotation thereof.

8). The irrigator of claim 1, wherein the means for cyclically varying a delivery of outletting liquid comprise a cover (11) which is removably fixed on a fixed member (6) and which bears a plurality of nozzles (13) having various characteristics, any nozzle of which plurality of nozzles (13) can be aligned with an outlet hole (16) afforded on the fixed member (6).
